(19) United States
(12) Patent Application Publication
(10) Pub. No.: US 2026/0122358 A1
(43) Pub. Date: Apr. 30, 2026

(54) IMAGE SENSOR AND OPERATING METHOD OF IMAGE SENSOR

(71) Applicant: SAMSUNG ELECTRONICS CO., LTD., Suwon-si (KR)

(72) Inventors: Dongpan LIM, Suwon-si (KR); Seongwook SONG, Suwon-si (KR); Jaeseong YU, Suwon-si (KR); Jeongguk LEE, Suwon-si (KR)

(73) Assignee: SAMSUNG ELECTRONICS CO., LTD., Suwon-si (KR)

(21) Appl. No.: 19/292,357

(22) Filed: Aug. 6, 2025

(30) Foreign Application Priority Data
Oct. 28, 2024 (KR) 10-2024-0148957

(51) Int. Cl. H04N 23/741; H04N 23/67; H04N 23/76; H04N 25/13; H04N 25/57

(52) U.S. Cl. CPC H04N 23/741; H04N 23/67; H04N 23/76; H04N 25/134; H04N 25/57

(57) ABSTRACT

Provided is an image sensor including a pixel array including pixels respectively including sub-pixels connected to a floating diffusion node, a first sub-pixel of a first pixel and a second sub-pixel of a second pixel corresponding to a first microlens, a readout circuit configured to generate first image data based on a first pixel signal output from the first sub-pixel and a second pixel signal output from the second sub-pixel, and generate second image data based on a third pixel signal output from sub-pixels, other than the first sub-pixel, of the sub-pixels of the first pixel and a fourth pixel signal output from sub-pixels, other than the second sub-pixel, of the sub-pixels of the second pixel, and an image signal processor configured to generate high dynamic range image data based on the first and second image data, and generate auto-focus information based on the first image data.

### CROSS-REFERENCE TO RELATED APPLICATION

This application claims priority to Korean Patent Application No. 10-2024-0148957, filed on Oct. 28, 2024, in the Korean Intellectual Property Office, the disclosure of which is incorporated by reference herein in its entirety.

### BACKGROUND

Embodiments of the present disclosure relate to an image sensor, and more particularly, to an image sensor generating high dynamic range (HDR) images and an operating method thereof.

The image sensor generates an image of an object by using a photoelectric converter that reacts to the intensity of light reflected from the object. The range of brightness that the image sensor can accommodate is narrower than the range of brightness that a human eye can accommodate. Accordingly, an HDR technique is used to generate an HDR image by synthesizing images having different brightness for the same subject. As the demand for high-resolution and high-quality image sensors has increased recently, the pixel structure of the pixel array or the pattern of the color filter array is diversifying. The HDR technique that is adaptively fast and reduces power consumption for pixel arrays has been studied.

### SUMMARY

One or more embodiments provide an image sensor capable of generating high dynamic range (HDR) image data at relatively high speed and low power, and an operating method of the image sensor.

According to an aspect of one or more embodiments, there is provided an image sensor, including a pixel array including a plurality of pixels in a matrix form, each pixel of the plurality of pixels including a plurality of sub-pixels in a plurality of rows and a plurality of columns and connected to a floating diffusion node, a first sub-pixel of a first pixel among the plurality of pixels and a second sub-pixel of a second pixel among the plurality of pixels corresponding to a first microlens, a readout circuit configured to generate first image data based on a first pixel signal output from the first sub-pixel and a second pixel signal output from the second sub-pixel, and generate second image data based on a third pixel signal output from sub-pixels, other than the first sub-pixel, of the plurality of sub-pixels of the first pixel and a fourth pixel signal output from sub-pixels, other than the second sub-pixel, of the plurality of the sub-pixels of the second pixel, and an image signal processor configured to generate high dynamic range (HDR) image data based on the first image data and the second image data, and generate auto-focus information based on the first image data.

According to another aspect of one or more embodiments, there is provided an image sensor, including a pixel array including a plurality of pixels in a matrix form, each pixel of the plurality of pixels including a plurality of sub-pixels in a plurality of rows and a plurality of columns and connected to a floating diffusion node, in a first pixel and a second pixel connected to adjacent column lines among the plurality of pixels, each of a first sub-pixel in the first pixel and a second sub-pixel in the second pixel includes a color filter of a first color, a readout circuit configured to generate first image data based on a first pixel signal generated from the first sub-pixel and a second pixel signal generated from the second sub-pixel, and generate second image data based on a third pixel signal generated from sub-pixels of the plurality of sub-pixels in the first pixel other than the first sub-pixel and a fourth pixel signal generated from sub-pixels of the plurality of the sub-pixels in the second pixel other than the second sub-pixel, and an image signal processor configured to generate high dynamic range (HDR) image data based on the first image data and the second image data and generate auto-focus information based on the first image data.

According to another aspect of one or more embodiments, there is provided an operating method of an image sensor, the operating method including receiving, by an analog-to-digital conversion (ADC) circuit, a plurality of phase detection pixel signals from a pixel array, generating, by the ADC circuit, first image data based on the plurality of phase detection pixel signals, receiving, by the ADC circuit, a plurality of summed pixel signals from the pixel array, generating, by the ADC circuit, second image data based on the plurality of summed pixel signals, and generating, by an image signal processor, auto-focus information and a high dynamic range (HDR) image based on the first image data and the second image data.

### BRIEF DESCRIPTION OF DRAWINGS

Embodiments will be more clearly understood from the following detailed description taken in conjunction with the accompanying drawings in which:

FIG. 1 is a block diagram of an image sensor according to one or more embodiments;

FIG. 2 is a diagram of an implementation of a pixel array included in the image sensor, according to one or more embodiments;

FIG. 3 is a diagram illustrating a method of operating an image sensor, according to one or more embodiments;

FIG. 4A is a schematic plan view of a pixel block of a pixel array provided in an image sensor, according to one or more embodiments, and FIG. 4B is a schematic cross-sectional view taken along line A-A′;

FIGS. 5A and 5B are equivalent circuit diagrams of implementations of a pixel included in an image sensor, according to one or more embodiments;

FIG. 6 is a timing diagram of a readout operation of a pixel of an image sensor, according to one or more embodiments;

FIGS. 7A and 7B are diagrams showing signal flows in a pixel in second and third periods in FIG. 6;

FIG. 8 is a diagram of an image signal processor to illustrate an operation of the image signal processor, according to one or more embodiments;

FIG. 9 is a diagram of an implementation of a pixel array included in an image sensor, according to one or more embodiments;

FIG. 10 is a diagram illustrating an operating method of an image sensor, according to one or more embodiments;

FIG. 11 is a diagram of an implementation of a pixel array included in an image sensor, according to one or more embodiments;

FIG. 12 is a diagram illustrating an operating method of an image sensor, according to one or more embodiments;

FIG. 13 is a diagram of an implementation of a pixel array included in an image sensor, according to one or more embodiments;

FIG. 14 is a flowchart of an operating method of an image sensor, according to one or more embodiments; and

FIG. 15 is a block diagram of an electronic device including an image sensor, according to one or more embodiments.

### DETAILED DESCRIPTION OF EMBODIMENTS

Hereinafter, various embodiments are described below with reference to the accompanying drawings.

It will be understood that, although the terms first, second, third, fourth, etc. may be used herein to describe various elements, components, regions, layers and/or sections (collectively “elements”), these elements should not be limited by these terms. These terms are only used to distinguish one element from another element. Thus, a first element described in this description section may be termed a second element or vice versa in the claim section without departing from the teachings of the disclosure.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

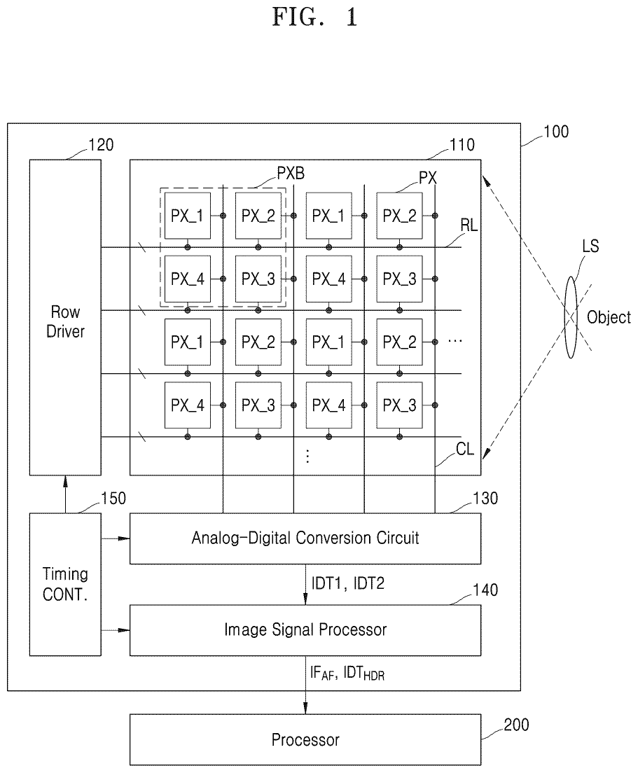

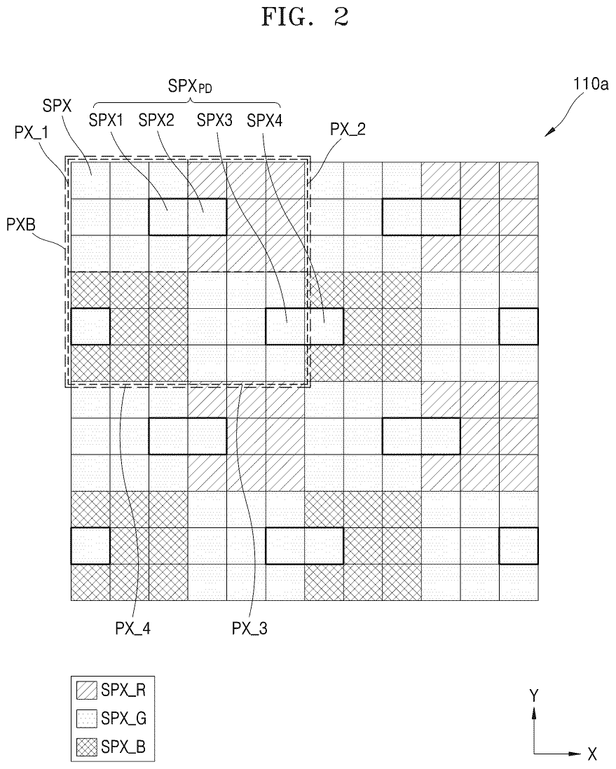

FIG. 1 is a block diagram of an image sensor according to one or more embodiments and FIG. 2 is a diagram of an implementation of a pixel array included in the image sensor, according to one or more embodiments.

An image sensor 100 may convert an optical signal of an object incident through an optical lens LS into image data. The image sensor 100 may be mounted on an electronic device having an image-sensing or light-sensing function. For example, the image sensor 100 may be mounted on an electronic device, such as a digital still camera, a digital video camera, a smartphone, a wearable device, an Internet of Things (IoT) device, a tablet personal computer (PC), a personal digital assistant (PDA), a portable multimedia player (PMP), a navigation device, or the like. In addition, the image sensor 100 may be mounted on an electronic device provided as a component in vehicles, furniture, manufacturing equipment, doors, various measurement devices, or the like.

Referring to FIG. 1, the image sensor 100 may include a pixel array 110, a row driver 120, an analog-digital conversion (ADC) circuit 130, an image signal processor 140, and a timing controller 150. In one or more embodiments, the pixel array 110, the row driver 120, the ADC circuit 130, the image signal processor 140, and the timing controller 150 may be implemented as one or more semiconductor chips or semiconductor modules.

The pixel array 110 includes a plurality of row lines RL, a plurality of column lines CL, and a plurality of pixels PX connected to the plurality of row lines RL and the plurality of column lines CL and arranged in a matrix. The pixels PX arranged at the same position in a column direction may be connected to the same column line CL.

The plurality of pixels PX may be arranged in a matrix. The pixel PX may sense light using a photoelectric converter and output an image signal that is an electrical signal according to the sensed light. The photoelectric converter may include a light-sensing device including an organic material or an inorganic material, such as a photodiode, an organic photodiode, a perovskite photodiode, a phototransistor, a photogate, or a pinned photodiode. Hereinafter, the photodiode may be described as an example of the photoelectric converter herein.

In the pixel array 110 according to one or more embodiments, the pixels PX may be distinguished into a first pixel PX_1, a second pixel PX_2, a third pixel PX_3, and a fourth pixel PX_4, and a pixel block PXB may include the first pixel PX_1, the second pixel PX_2, the third pixel PX_3, and the fourth pixel PX_4, arranged in a 2×2 matrix. A plurality of pixel blocks PXB may be repeatedly arranged. In one or more embodiments, the first pixel PX_1, the second pixel PX_2, the third pixel PX_3, and the fourth pixel PX_4 may correspond to green, red, green, and blue, respectively. However, embodiments are not limited thereto. The first pixel PX_1, the second pixel PX_2, the third pixel PX_3, and the fourth pixel PX_4 may correspond to different colors. For example, the first pixel PX_1, the second pixel PX_2, the third pixel PX_3, and the fourth pixel PX_4 may respectively correspond to green, red, white, and blue, or may correspond to green, yellow, green, and cyan.

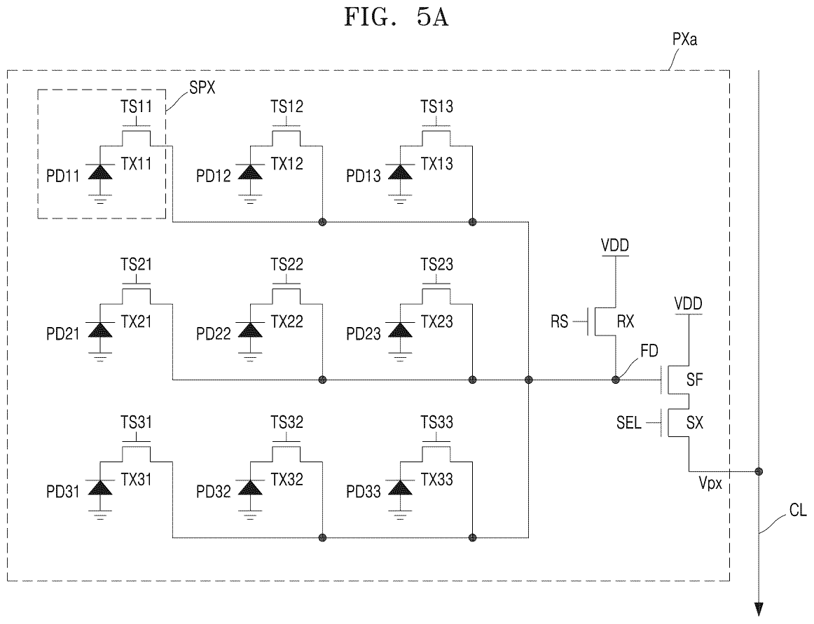

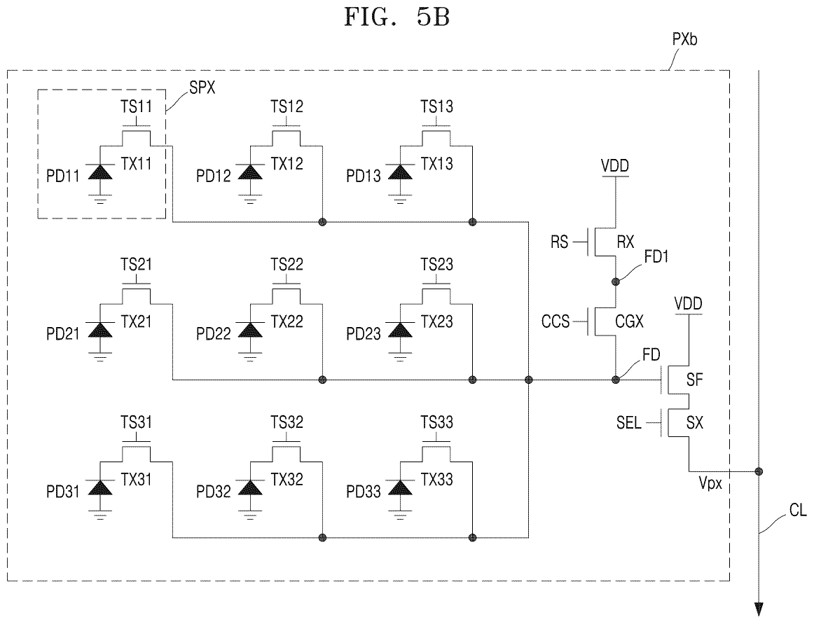

Each of the plurality of pixels PX may include a plurality of sub-pixels (e.g., SPX in FIG. 2) arranged in an N×N matrix (where N is an integer of 2 or greater). The plurality of sub-pixels included in one pixel may share a floating diffusion node (e.g., FD in FIGS. 5A and 5B). Each of the plurality of sub-pixels may include a photodiode and a transfer transistor which transfers charge generated by photodiode to the floating diffusion node. The transfer transistors included in one pixel may be connected to the same floating diffusion node. As such, a pixel structure in which the plurality of sub-pixels share one floating diffusion node may be referred to as a shared pixel structure. Each sub-pixel may further include a microlens and a color filter and may convert an optical signal according to a color of the color filter, among optical signals received through the microlens, into charge. For example, the photodiode may receive the optical signal transmitted through the color filter, convert the received optical signal into charge, and store (or accumulate) the charge.

For example, a red color filter, a blue color filter, and a green color filter may be applied to the pixel array 110. The sub-pixels may be distinguished into a red sub-pixel, a blue sub-pixel, and a green sub-pixel. At least half of the plurality of sub-pixels of each of the first pixel PX_1 and the third pixel PX_3 may include green sub-pixels. More than half of the sub-pixels of the second pixel PX_2 may include red sub-pixels. More than half of the sub-pixels of the fourth pixel PX_4 may include blue sub-pixels.

The pixel array 110 may be described in more detail with reference to FIG. 2. A pixel array 110a of FIG. 2 may be applied to the pixel array 110 in FIG. 1.

Referring to FIG. 2, each of the plurality of pixels PX may include nine sub-pixels SPX arranged in a 3×3 matrix (in a Y-axis direction and an X-axis direction). For example, the first pixel PX_1 and the third pixel PX_3 may include nine green sub-pixels SPX_G, the second pixel PX_2 may include eight red sub-pixels SPX_R and one green sub-pixel SPX_G, and the fourth pixel PX_4 may include eight blue sub-pixels SPX_B and one green sub-pixel SPX_G.

In one or more embodiments, at least one sub-pixel SPX among the plurality of sub-pixels SPX included in the pixel PX may include a phase detection sub-pixel SPXPD (or referred to as an auto-focus sub-pixel) that generates a phase difference signal for auto-focusing of the optical lens LS. For example, in the pixel array 110a of FIG. 2, a first sub-pixel SPX1 of the first pixel PX_1, a second sub-pixel SPX2 of the second pixel PX2, a third sub-pixel SPX3 of the third pixel PX_3, and a fourth sub-pixel SPX4 of the fourth pixel PX_4 may include phase detection sub-pixels SPXPD.

A pair of adjacent phase detection sub-pixels SPXPD may share and correspond to a microlens and may include sub-pixels of the same color including a color filter of the same color. For example, the first sub-pixel SPX1 of the first pixel PX_1 and the second sub-pixel SPX2 of the second pixel PX_2 may share and correspond to a microlens and may include the green sub-pixels SPX_G. The third sub-pixel SPX3 of the third pixel PX_3 and the fourth sub-pixel SPX4 of the fourth pixel PX_4 share and correspond to a microlens and may include the green sub-pixel SPX_G.

The optical axis of the microlens may be located between the pair of phase detection sub-pixels SPXPD (e.g., the first sub-pixel SPX1 and the second sub-pixel SPX2). The first sub-pixel SPX1 and the second sub-pixel SPX2 may receive optical signals received through the left and right sides of the micro-lens about the optical axis, respectively, to generate a pair of phase detection pixel signals. For example, the first sub-pixel SPX1 may generate a first pixel signal (e.g., a left pixel signal) and the second sub-pixel SPX2 may generate a second pixel signal (e.g., a right pixel signal).

Referring to FIG. 1, the row driver 120 and the ADC circuit 130 may read out pixel signals from the pixel array 110 under the control by the timing controller 150 to generate image data, which may be collectively referred to as a readout circuit.

The row driver 120 (or referred to as a row driving circuit) drives the pixel array 110 in units of rows. The row driver 120 may provide control signals to the pixels PX arranged in the row selected by a selection signal provided from the timing controller 150. For example, the control signals may include a reset control signal, transfer control signals, and a selection signal. The control signals may further include a conversion control signal. The row driver 120 may provide the control signals through the plurality of row lines RL connected to the pixels PX arranged in a row. The pixel PX may operate in response to the control signals, thereby outputting a pixel signal.

The ADC circuit 130 may generate image data based on pixel signals received through the column lines CL. Based on a timing signal (e.g., clock signal) provided from the timing controller 150, the ADC circuit 130 may generate pixel data by performing analog-to-digital conversion on each of the pixel signals received through the column lines CL. The ADC circuit 130 may perform analog-to-digital conversion in parallel on the pixel signals received through the column lines CL.

The ADC circuit 130 may generate image data by comparing each of the pixel signals received through the plurality of column lines CL with a ramp signal (e.g., a ramp voltage) of which the level rises or falls at a certain slope and counting each of the comparison results. The image data may include pixel data corresponding to a pixel PX or a sub-pixel, wherein the pixel data may include a pixel value corresponding to a pixel signal. In one or more embodiments, the ADC circuit 130 may convert a pixel signal into pixel data, according to a correlated double sampling (CDS) method.

When the image sensor 100 operates in a full mode for generating a relatively high-resolution image, the row driver 120 may control the pixel array 110 such that pixel signals generated from the plurality of sub-pixels in each pixel PX are time-divisionally output through each column line CL. The ADC circuit 130 may generate relatively high-resolution image data based on the received pixel signals.

When the image sensor 100 operates in a preview mode or a video mode, the row driver 120 may control the pixel array 110 to sum pixel signals generated from two or more sub-pixels SPX in each pixel PX and output the summed pixel signals through the column lines CL. The ADC circuit 130 may generate relatively low-resolution image data based on the received pixel signals.

In addition, the image sensor 100 may operate in an HDR mode and the row driver 120 may control the pixel array 110 such that pixel signals (hereinafter, referred to as phase detection pixel signals) generated from phase detection sub-pixels in each pixel PX are output through the column lines CL and summed pixel signals obtained by summing pixel signals generated from all of the plurality of sub-pixels or other sub-pixels than the phase detection sub-pixels among the plurality of sub-pixels in each pixel PX are output through the column lines CL.

The ADC circuit 130 may generate first image data IDT1 by performing analog-to-digital conversion on the plurality of phase detection pixel signals received through the plurality of column lines CL in a first period of a readout period and may generate second image data IDT2 by performing ADC on the plurality of summed pixel signals received through the plurality of column lines CL in a second period of the readout period. The luminance (or brightness) of the first image data IDT1 may be less than the luminance of the second image data IDT2.

The image signal processor 140 may perform image processing on the image data provided from the ADC circuit 130 and may output the image-processed image data to an external processor 200 (e.g., an application processor). For example, the image signal processor 140 may perform image processing, such as dark level correction, bad pixel correction, crosstalk correction, lens shading correction, demosaic, and re-mosaic, on the received image data.

In addition, the image signal processor 140, according to one or more embodiments, may receive the first image data IDT1 having a first luminance and the second image data IDT2 having a second luminance different from the first luminance, generate auto-focus information IF_{AF} based on the first image data IDT1, and generate HDR image data IDT_{HDR} based on the first image data IDT1 and second image data IDT2. The auto-focus information IF_{AF} and the HDR image data IDT_{HDR} may be output to the external processor 200.

The timing controller 150 may output control signals to each of the row driver 120, the ADC circuit 130, and the image signal processor 140 to control the operation or timing of the row driver 130, the ADC circuit 130, and the image signal processor 140.

As described above, the image sensor 100, according to one or more embodiments, may generate the first image data IDT1 based on the phase detection pixel signals generated from the phase detection sub-pixels and may generate the second image data IDT2 based on the summed pixel signals generated by summing pixel signals of different sub-pixels. The first image data IDT1 may include auto-focusing data (e.g., left pixel data corresponding to the left pixel signal and light pixel data corresponding to the light pixel signal) used to calculate or obtain the auto-focus information for auto-focusing. The luminance of the first image data IDT1 may be less than the luminance of the second image data IDT2.

The image sensor 100 may generate the auto-focus information IF_{AF} and the HDR image data IDT_{HDR} based on the first image data IDT1. The first image data IDT1 generated based on the phase detection pixel signals may be used to generate the auto-focus information IF_{AF} and may also be used to generate the HDR image data IDT_{HDR}. Thus, a separate reading operation for generating relatively low-luminance image data may not be required to generate the HDR image data IDT_{HDR}, thereby reducing the number of readout operations and the readout time. Accordingly, the frame rate of the image sensor 100 may be increased and power consumption may be reduced.

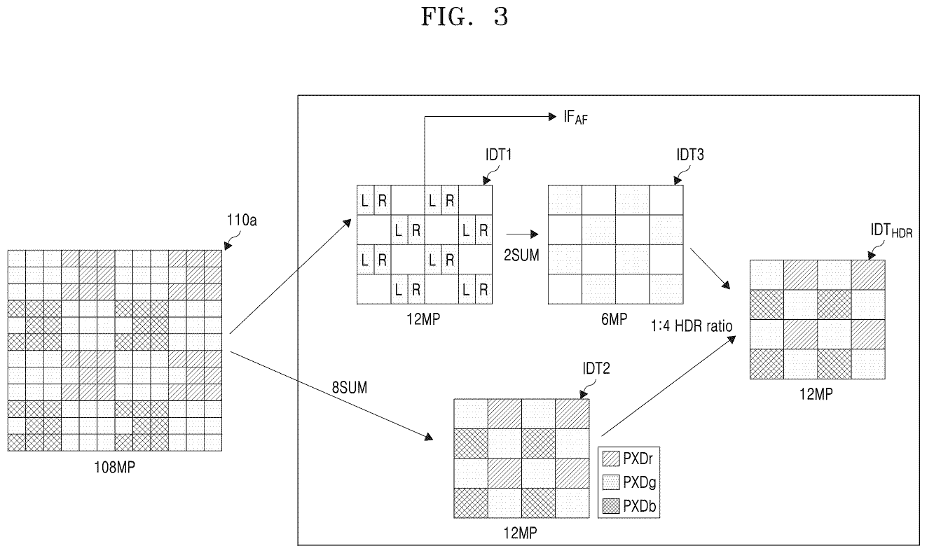

FIG. 3 is a diagram illustrating a method of operating an image sensor, according to one or more embodiments. FIG. 3 schematically illustrates a method in which the image sensor (100 in FIG. 1) generates the auto-focus information IF_{AF} and the HDR image data IDT_{HDR} based on pixel signals read out from the pixel array 110a of FIG. 2 in the HDR mode.

Referring to FIGS. 1, 2, and 3, the ADC circuit (130 of FIG. 1) may receive the plurality of phase detection pixel signals from the plurality of phase detection sub-pixels SPXPD of the pixel array 110a and may generate the first image data IDT1 based on the plurality of phase detection pixel signals. The first image data IDT1 may include a plurality of pieces of pixel data respectively corresponding the phase detection pixel signals generated from the plurality of phase detection sub-pixels SPXPD. The plurality of phase detection sub-pixels SPXPD may include the green sub-pixel SPX_G, and the first image data IDT1 may include green image data including a plurality of pieces of green pixel data PXDg. For example, when the pixel array 110a has a resolution of 108 megapixels (MP) (e.g., when full image data generated in the full mode has a resolution of 108 MP), the first image data IDT1 may have a resolution of 12 MP, which is 1/9 times the resolution of the pixel array 110a.

The first image data IDT1 may include first pixel data L (e.g., left pixel data) and second pixel data R (e.g., right pixel data). The first pixel data L corresponds to a pixel signal generated from a phase detection sub-pixel SPXPD located in a first direction among a pair of phase detection sub-pixels SPXPD sharing the microlens and the second pixel data R corresponds to a pixel signal generated from a phase detection sub-pixel SPXPD located in a second direction (opposite to the first direction) among the pair of phase detection sub-pixels SPXPD. For example, the first pixel data L corresponds to a first pixel signal generated from the first sub-pixel SPX1 in the first pixel PX1 and the second pixel data R corresponds to a second pixel signal generated from the second sub-pixel SPX2 in the second pixel PX2.

The ADC circuit 130 may receive the plurality of summed pixel signals from the pixel array 110a and may generate the second image data IDT2 based on the plurality of summed pixel signals. Each piece of pixel data of the second image data IDT2 has a value which is the sum of pixel signals generated from eight sub-pixels SPX, other than the phase detection sub-pixel SPXPD, among nine sub-pixels SPX of the corresponding pixel PX in the pixel array 110a. Four pieces of pixel data arranged in a 2×2 matrix in the second image data IDT2 may correspond to the first pixel PX_1, the second pixel PX_2, the third pixel PX_3, and the fourth pixel PX_4 of the pixel array 110a, respectively. The four pieces of pixel data may include green pixel data PXDg, red pixel data PXDr, green pixel data PXDg, and blue pixel data PXDb, respectively. The second image data IDT2 may include image data of a Bayer pattern. The Bayer pattern may refer to a pattern in which a red pixel, a green pixel, and a blue pixel are alternately arranged such that a green color is 50%, a red color is 25%, and a blue color is 25%, according to visual characteristics of humans that are most sensitive to the green color. When the pixel array 110a has a resolution of 108 MP, the second image data IDT2 may have a resolution of 12 MP, which is 1/9 times the resolution of the pixel array 110a.

The image signal processor 140 may generate the auto-focus information IF_{AF} based on the first image data IDT1. The image signal processor 140 may detect a phase difference between an image according to the plurality of pieces of first pixel data L and an image according to the plurality of pieces of second pixel data R in the first image data IDT1 and may generate the auto-focus information IF_{AF} including the detected phase difference.

The image signal processor 140 may generate the third image data IDT3 by summing (or digital summing) the first pixel data L and the second pixel data R of the first image data IDT1. The third image data IDT3 may have a resolution of 6 MP.

A method of summing pixel signals includes an analog summing method and a digital summing method. According to the analog summing method, the ADC circuit 130 sums and reads out pixel signals (e.g., charge stored in the photodiode) generated from sub-pixels, and according to digital summing method, the ADC circuit 130 reads out and converts the pixel signals stored in each sub-pixel into pixel data, and the image signal processor 140 sums a plurality of pixel data corresponding to sub-pixels in a digital domain.

In the analog summing method, the charge stored in the plurality of sub-pixels may be output as a single pixel signal. Thus, compared to the digital summing method, the number of readouts may be reduced and the noise in the output pixel signal is less than that of the digital summing method as the readout noise occurs once. Therefore, the second image data IDT2 may have greater luminance and less noise than the third image data IDT3.

The image signal processor 140 may generate the HDR image data IDT_{HDR} by merging the third image data IDT3 with the second image data IDT2. Since the third image data IDT3 includes the green pixel data PXDg, the HDR image data IDT_{HDR} with an extended dynamic range of the green pixel data PXDg may be generated from the second image data IDT2.

The resolution of the HDR image data IDT_{HDR} may be 12 MP, which is the same as the resolution of the second image data IDT2. In the third image data IDT3, the green pixel data PXDg has a value 2SUM, which is the digital sum of pixel signals of two green sub-pixels SPX_G. In the second image data IDT2, the green pixel data PXDg has a value 8SUM, which is the sum of pixel signals of eight green sub-pixels SPX_G. Thus, an HDR ratio of the third image data IDT3 to the second image data IDT2 may be 1:4.

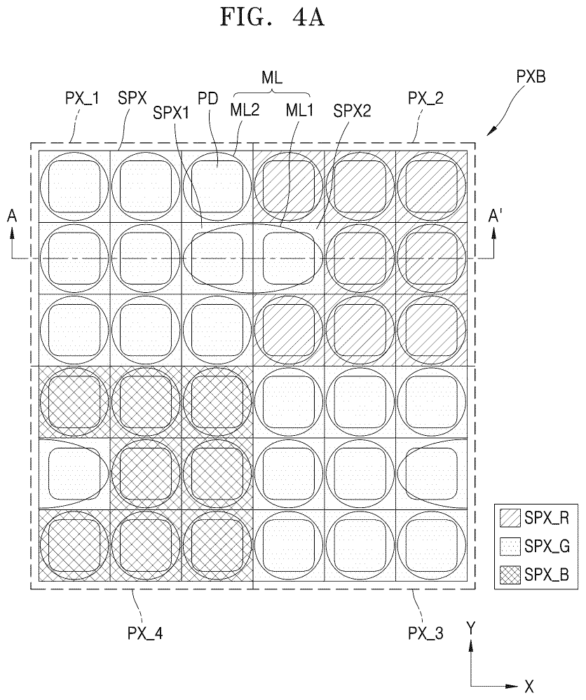

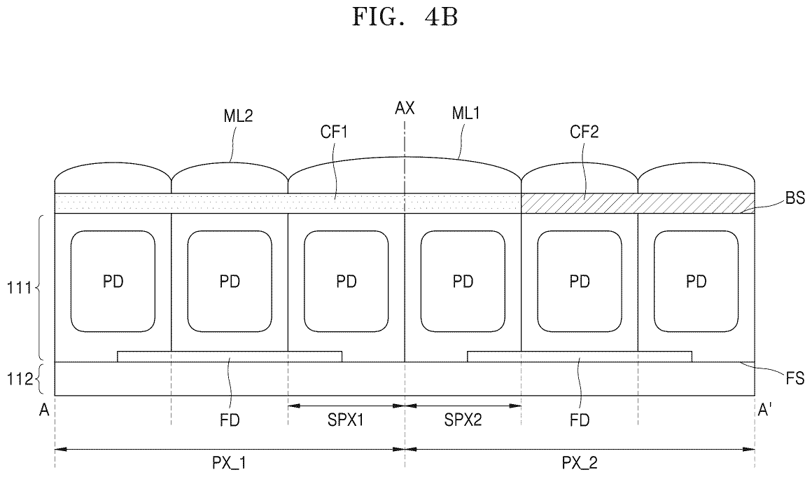

FIG. 4A is a schematic plan view of a pixel block of a pixel array provided in an image sensor, according to one or more embodiments, and FIG. 4B is a schematic cross-sectional view taken along line A-A′. The pixel block PXB indicates a pixel block of the pixel array 110a of FIG. 2.

Referring to FIG. 4A, the pixel block PXB may include a first pixel PX_1, a second pixel PX_2, a third pixel PX_3, and a fourth pixel PX_4. The first pixel PX_1 and the third pixel PX_3 may each include nine green sub-pixels SPX_G, the second pixel PX_2 may include eight red sub-pixels SPX_R and one green sub-pixel SPX_G, and the fourth pixel PX_4 may include eight blue sub-pixels SPX_B and one green sub-pixel SPX_G.

Each of the plurality of sub-pixels SPX may include a photodiode PD, a microlens ML, and a color filter (CF1 or CF2 in FIG. 4B). In a pair of pixels adjacent to each other in the first direction, such as the X-axis direction, for example, in the first pixel PX_1 and the second pixel PX_2, and the third pixel PX_3 and the fourth pixel PX_4, adjacent sub-pixels (e.g., the first sub-pixel SPX1 and the second sub-pixel SPX2) of the same color may share and correspond to the first microlens ML1 and may include the color filter of the same color.

Referring to FIG. 4B, the pixel array (110a of FIG. 2) may include a semiconductor substrate 111 including a first surface BS and a second surface FS, wherein the semiconductor substrate 111 may include, for example, silicon, germanium, silicon-germanium, a group-VI compound semiconductor, a group-V compound semiconductor, or the like. The semiconductor substrate 111 may include a silicon substrate implanted with P-type impurity or N-type impurity. The semiconductor substrate 111 implanted with P-type impurities may be described herein as an example.

The semiconductor substrate 111 may include a plurality of photoelectric converters located in each areas of sub-pixels SPX, e.g., a plurality of photodiodes PD, and may include floating diffusion nodes FD. The semiconductor substrate 111 may further include deep trench solations (DTI) located between the adjacent pixels PX and between the adjacent sub-pixels SPX and distinguishing the pixels PX and sub-pixels. The photodiode PD may be located between the DTIs.

The photodiode PD may be formed by ion-implanting impurities having a conductivity type opposite to that of the semiconductor substrate 111, e.g., N-type impurities, into the semiconductor substrate 111. The photodiode PD may be formed by stacking a plurality of doped regions. The floating diffusion node FD may be formed as, for example, a region doped with N-type impurities. In FIG. 4B, the floating diffusion node FD extends in the first direction, for example, the X-axis direction, and is physically shared by the plurality of sub-pixels SPX of one pixel (e.g., the first pixel PX_1). However, embodiments are not limited thereto. The sub-pixel SPX may include each of the floating diffusion nodes FD that are physically spaced apart from each other. The floating diffusion nodes FD may be electrically connected to each other through wiring formed in a wiring layer 112.

A plurality of color filters CF1 and CF2 and microlenses ML1 and ML2 may be located on the first surface BS of the semiconductor substrate 111. The first microlens ML1 may be disposed on the first sub-pixel SPX1 and the second sub-pixel SPX2. The first sub-pixel SPX1 and the second sub-pixel SPX2 may share and correspond to the first microlens ML1. The second microlens ML2 may be disposed on each of the other sub-pixels SPX. The shape of the first microlens ML1 may be different from the shape of the second microlens ML2. For example, the first microlens ML1 may be elliptical and the second microlens ML2 may be circular. On the X axis, an optical axis AX of the first microlens ML1 may be at the center between the first sub-pixel SPX1 and the second sub-pixel SPX2.

Each of the sub-pixels SPX may include a color filter CF1 or CF2. The plurality of sub-pixels SPX of the first pixel PX_1 and the second sub-pixel SPX2 of the second pixel PX_2 may include the first color filter CF1. For example, the first color filter CF1 may selectively pass or transmit an optical signal of green color. The sub-pixels SPX, other than the second sub-pixel SPX2, among the plurality of sub-pixels SPX of the second pixel PX_2 may include the second color filter CF2. For example, the second color filter CF2 may selectively pass or transmit an optical signal of red color. The plurality of sub-pixels SPX of the third pixel PX_3 and one sub-pixel, e.g., the phase detection sub-pixel, of the fourth pixel PX_4 may include the first color filter CF1. The sub-pixels SPX, other than the phase detection sub-pixel, among the plurality of sub-pixels SPX of the fourth pixel PX_4 may include a third color filter. For example, the third color filter may selectively pass or transmit an optical signal of blue color.

The wiring layer 112 may be located on the second surface FS of the semiconductor substrate 111. The wiring layer 112 may include a plurality of transistors included in the pixel PX and a plurality of wirings connected thereto. Unlike shown, the wiring layer 112 may be arranged between the semiconductor substrate 111 and the color filters CF1 and CF2.

FIGS. 5A and 5B are equivalent circuit diagrams of implementations of a pixel included in an image sensor, according to one or more embodiments.

Referring to FIGS. 5A and 5B, a pixel PXa may include a plurality of photodiodes PD11 to PD33, a plurality of transfer transistors TX11 to TX33, a reset transistor RX, a source follower SF (or referred to as a driving transistor), and a select transistor SX. The reset transistor RX, the source follower SF (or referred to as a driving transistor), and the select transistor SX may be referred to as a pixel circuit.

The reset transistor RX may be turned on and off in response to the received reset control signal RS. The reset transistor RX may be turned on to provide a power supply voltage VDD to the floating diffusion node FD, thereby removing the charge remaining in the floating diffusion node FD. Accordingly, the floating diffusion node FD may be reset.

Each of the plurality of photodiodes PD11, PD12, PD13, PD21, PD22, PD23, PD31, PD32, and PD33 may generate charge (or photocharge) that varies depending on the intensity of received light. The photocharge may be accumulated (or stored) in the photodiode during the accumulation period.

The plurality of transfer transistors TX11, TX12, TX13, TX21, TX22, TX23, TX31, TX32, and TX33 may be turned on and off in response to the corresponding transfer control signal of the plurality of transfer control signals TS11, TS12, TS13, TS21, TS22, TS23, TS31, TS32, and TS33. Each of the plurality of transfer transistors TX11 to TX33 may be connected to the corresponding photodiode of the plurality of photodiodes PD11 to PD33 and the floating diffusion node FD, and may be turned on to transfer charge generated from the corresponding photodiode to the floating diffusion node FD.

The source follower SF may generate a pixel signal corresponding to the potential of the floating diffusion node FD. A gate terminal of the source follower SF may receive the signal (e.g., voltage) corresponding to the potential of the floating diffusion node FD. The source follower SF may buffer the received signal and output the buffered signal as a pixel voltage Vpx. The select transistor SX may be turned on and off in response to a selection signal SEL and may be turned on to output the pixel voltage Vpx provided from the source follower SF to the column line CL.

For example, when the transfer transistor TX23 of the plurality of transfer transistors TX11 to TX33 is turned on during the readout period, the charge accumulated in the photodiode PD23 may be transferred to the floating diffusion node FD and the signal corresponding to the potential of the floating diffusion node FD, that is, the pixel signal generated from the photodiode PD23, may be output as the pixel voltage Vpx. For example, when the transfer transistors TX11 to TX13, TX21 to TX22, and TX31 to TX33 among the plurality of transfer transistors TX 11 to TX33 are turned on during the readout period, the charge accumulated in the photodiodes PD11 to PD13, PD21 to PD22, and PD31 to PD33 may be transferred to the floating diffusion node FD and the signal corresponding to the potential of the floating diffusion node FD, that is, a summed pixel signal which is the sum of the pixel signals generated from the photodiodes PD11 to PD13, PD21 to P22, and PD31 to PD33, may be output as the pixel voltage Vpx.

One photodiode (e.g., photodiode PD11) and one transfer transistor (e.g., transfer transistor TX11) corresponding thereto are included in one sub-pixel SPX. Therefore, the plurality of sub-pixels SPX share and correspond to the floating diffusion node FD. In addition, the plurality of sub-pixels SPX may share and correspond to the reset transistor RX, the source follower SF (or referred to as the driving transistor), and the select transistor SX.

Referring to FIG. 5B, a pixel PXb may further include a conversion gain transistor CGX. The conversion gain transistor CGX may be connected between the reset transistor RX and the floating diffusion node FD. The conversion gain transistor CGX may be turned on or off in response to a conversion control signal CCS. When the conversion gain transistor CGX is turned on, a node FDI may be electrically connected to the floating diffusion node FD, thereby increasing the capacitance of the floating diffusion node FD.

The conversion gain of the pixel PXb may be inversely related to the capacitance of the floating diffusion node FD. The conversion gain when the conversion gain transistor CGX is turned off is higher than the conversion gain when the converting gain transistor CGX is turned on. Therefore, when the conversion gain transistor CGX is turned off, the conversion gain may be referred to as a high conversion gain (HCG) mode. When the conversion gain transistor CGX is turned on, the conversion gain may also be referred to as a low conversion gain (LCG) mode.

When the amount of light incident on the pixel array 110 of the image sensor (100 in FIG. 1) is relatively small at night or in a dark environment, the pixel array 110 may operate in the HCG mode. As a signal to noise ratio (SNR) of the image sensor (100 of FIG. 1) is increased, the minimum amount of detectable light may be reduced and the low-light detection performance of the image sensor 100 may be improved. When the amount of light incident on the pixel array 110 of the image sensor 100 is large during the day or in a bright environment, the pixel array 110 may operate in the LCG mode. A full well capacity (FWC) of the pixel PX may be increased, and thus, the high-light detection performance of the image sensor 100 may be improved. As such, the pixel PXb may provide a dual conversion gain, enabling the image sensor 100 to generate high quality images in bright and dark environments.

In FIGS. 5A and 5B, the pixels PXa and PXb are illustrated as including nine photodiodes PD11 to PD33 and nine transfer transistors TX11 to TX33. However, this is an example. The pixel (PX in FIG. 1) provided in the image sensor according to one or more embodiments may include N2 photodiodes arranged in an N×N matrix and N2 transfer transistors corresponding thereto.

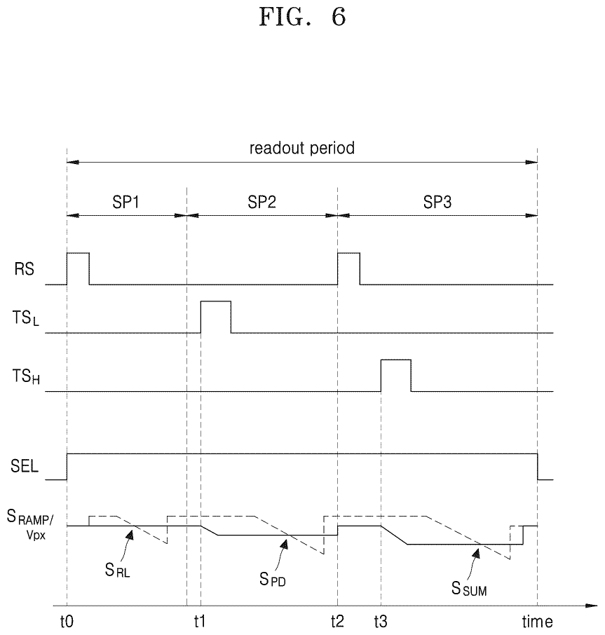

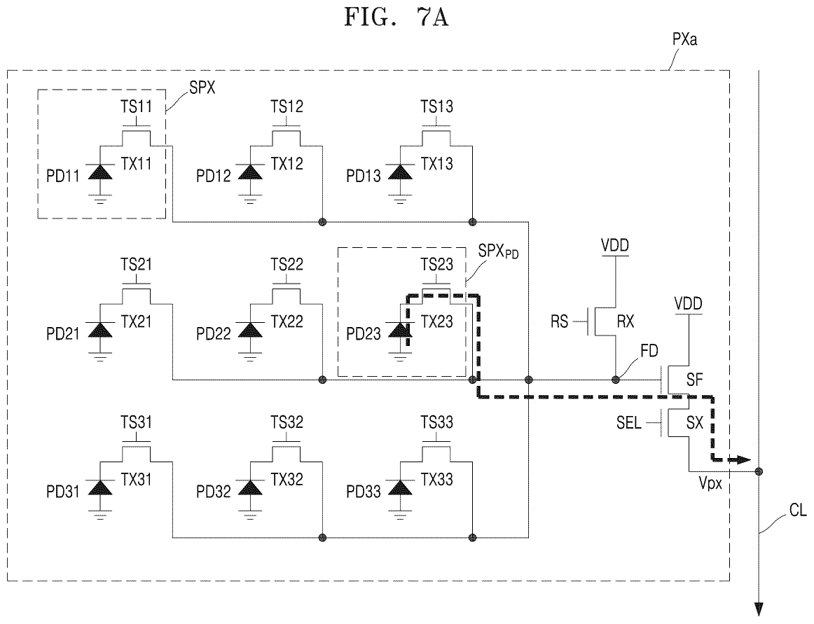

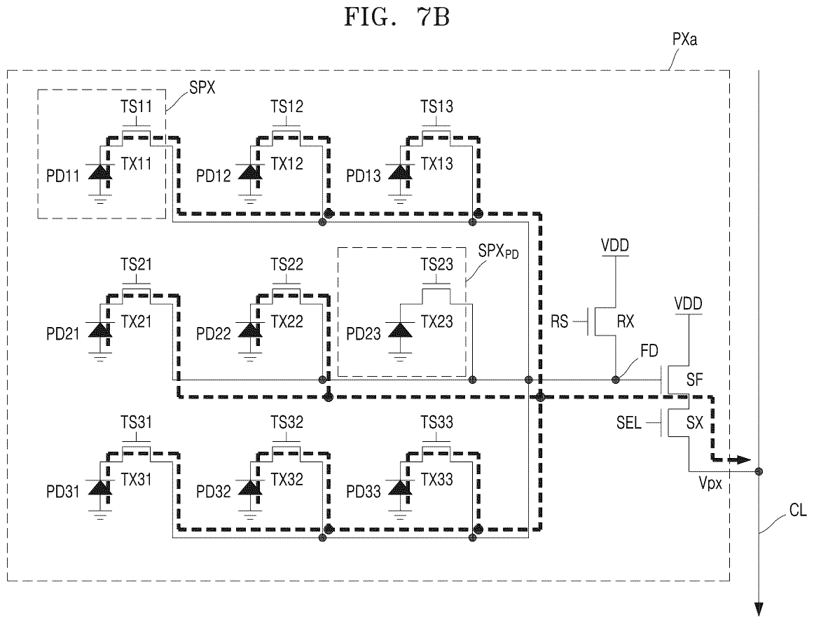

FIG. 6 is a timing diagram of a readout operation of a pixel of an image sensor, according to one or more embodiments. FIG. 6 illustrates a readout operation of the pixel (PXa in FIG. 5A) applied to the pixel array 110a in FIG. 2. FIGS. 7A and 7B are diagrams showing signal flows in a pixel in second and third periods in FIG. 6. It is assumed that the photodiode PD23 and the transfer control transistor TX23 in the pixel PXa are included in the phase detection sub-pixel SPXPD.

The pixel array (110 of FIG. 1) may be sequentially read out in units of rows after an integrated period (or referred to as an exposure period). Referring to FIGS. 5A and 6, in a readout period of one row, the pixel PXa may receive the selection signal SEL at an active level (e.g., logic high). The pixel PXa may be electrically connected to the column line CL. Accordingly, the pixel voltage Vpx output from the pixel PXa may be output to the column line CL.

The readout period may include a first period SP1, a second period SP2, and a third period SP3. The reset control signal RS may be toggled at the beginning of the first period SP1, for example, at time t0. The reset transistor RX may be turned on in response to the active level of the reset control signal RS and the floating diffusion node FD may be reset. The reset transistor RX may then be turned off in response to the inactive level of the reset control signal RS. A pixel signal indicating a reset level of the pixel PXa, e.g., a reset level of the pixel PXa corresponding to the potential of the reset floating diffusion node FD, may be output as the pixel voltage Vpx. The ADC circuit (130 in FIG. 1) may out a reset level signal S_{RL} of the pixel PXa by comparing the pixel voltage Vpx of the reset level with a ramp signal S_{RAMP}.

A phase detection pixel signal SPD may be read out from the pixel PXa during the second period SP2. The transfer control signal TSL may be toggled at time t1. The transfer control signal TSL may be provided to a transfer transistor (e.g., transfer transistor TX23) provided in the phase detection sub-pixel SPXPD. As illustrated in FIG. 7A, a charge generated from a photodiode (e.g., photodiode PD23) provided in the phase detection sub-pixel SPXPD may be provided to the floating diffusion node FD. The pixel voltage Vpx corresponding to the phase detection pixel signal SPD generated from the photodiode PD23 may be output through the column line CL. The ADC circuit 130 may read out the phase detection pixel signal SPD of the pixel PXa by comparing the ramp signal S_{RAMP} with the pixel voltage Vpx corresponding to the phase detection pixel signal SPD. The ADC circuit 130 may generate the first image data (IDT1 of FIG. 3) based on the received phase detection pixel signal SPD.

The summed pixel signal S_{SUM} may be read out from the pixel PXa during the third period SP3. At time t2, the reset control signal RS may be toggled again. Accordingly, the floating diffusion node FD may be reset. Then, the transfer control signal TSH may be toggled at time t3. The transfer control signal TSH may be provided to the transfer transistors (e.g., transfer transistors TX11 to TX13, TX21 to TX22, and TX31 to TX33) provided in the sub-pixels SPX, other than the phase detection sub-pixels SPXPD, among the plurality of sub-pixels SPX provided in the pixel PXa. As illustrated in FIG. 7B, charges generated from the photodiodes (e.g., PD11 to PD13, PD21 to PD22, and PD31 to PD33) provided in the sub-pixels SPX may be provided to the floating diffusion node FD. Accordingly, the pixel voltage Vpx having a level obtained by summing the pixel signals generated from the photodiodes (e.g., PD11 to PD13, PD21 to PD22, and PD31 to PD33) may be output through the column line CL. For example, the pixel voltage Vpx corresponding to the summed pixel signal S_{SUM} may be output to the ADC circuit 130 through the column line CL. The ADC circuit 130 may read out the summed pixel signal S_{SUM} of the pixel PXa by comparing the ramp signal S_{RAMP} with the pixel voltage Vpx corresponding to the summed pixel signal S_{SUM}. The ADC circuit 130 may generate the second image data (IDT2 in FIG. 3) based on the received summed pixel signal S_{SUM}.

In FIG. 6, it is illustrated that the reset level signal S_{RL} is read out during the first period SP1. However, embodiments are not limited thereto. In another embodiment, after the reset control signal RS is toggled during the third period SP3, the reset level signal S_{RL} may be read out once again before the transfer control signal TSH is toggled.

As described with reference to FIG. 6, the image sensor (100 of FIG. 1) may generate the first image data IDT1 and the second image data IDT2 by performing one or two pixel signal readouts, for example, a readout of the phase detection pixel signal SPD and a readout of the summed pixel signal S_{SUM}, during the readout period.

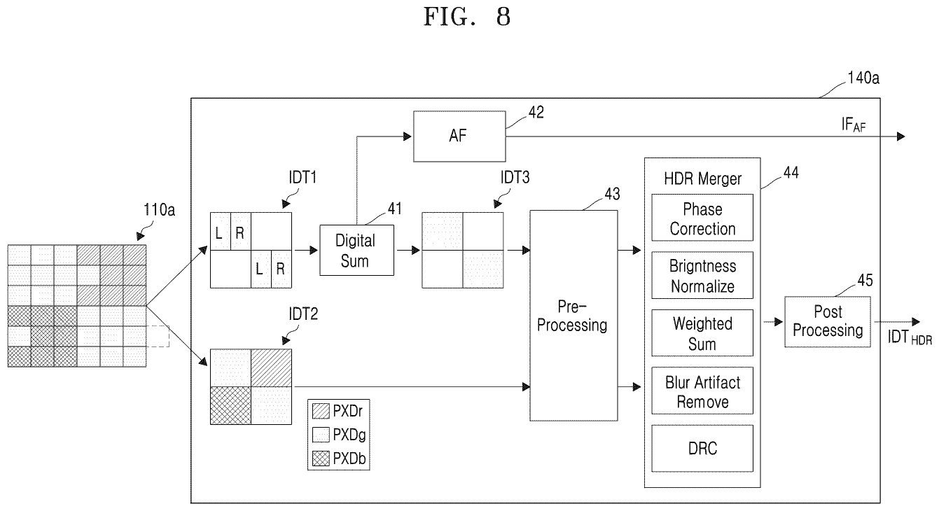

FIG. 8 is a diagram of an image signal processor to illustrate an operation of the image signal processor, according to one or more embodiments. An image signal processor 140a of FIG. 8 may be applied to the image sensor 100 of FIG. 1.

Referring to FIG. 8, the image signal processor 140a may include a plurality of processing modules (or a plurality of processing circuits), for example, a first module 41, a second module 42, a third module 43, a fourth module 44, and a fifth module 45.

The image signal processor 140a may receive first image data IDT1 generated based on the plurality of phase detection pixel signals generated from the pixel array 110a and second image data IDT2 generated based on the plurality of summed pixel signals output from the pixel array 110a.

The first image data IDT1 may be provided to the first processing module 41. The first processing module 41 may perform a processing operation on the first image data IDT1. For example, the first processing module 41 may generate third image data IDT3 by summing (or digital summing) the first pixel data L and the second pixel data R. The first processing module 41 may also distinguish image data according to the first pixel data L, e.g., first auto-focusing data, and image data according to the second pixel data R, e.g., second auto-focusing data, from the first image data IDT1. The first auto-focusing data and the second auto-focusing data may be provided to the second processing module 42.

The second processing module 42 may detect a phase difference between the images of the first and second auto-focusing data and generate auto-focus information IF_{AF} including the detected phase difference. In one or more embodiments, the second processing module 42 may correct characteristics of the first and second auto-focusing data and generate, as auto-focus information IF_{AF}, the first and second auto-focusing data having characteristics that are corrected. The auto-focus information IF_{AF} may be provided to the external processor (200 of FIG. 1), such as an application processor.

The third processing module 43 may include various image processing circuits that perform pre-processing on the third image IDT3 and the second image IDT2. For example, the third processing module 43 may perform image processing, such as dark level correction, bad pixel correction, crosstalk correction, lens shading correction, and demosaic, on the third image IDT3 and the second image IDT2. The third processing module 43 may include processing circuits that each perform the foregoing various types of image processing.

The third processing module 43 may receive the third image data IDT3 and the second image data IDT2 and perform at least one of the foregoing various types of image processing on the third image data IDT3 and the second image data IDT2 before the HDR processing.

The fourth processing module 44 may receive the third image data IDT3 and the fourth image data IDT4 pre-processed by the third processing module 43 and may generate the HDR image IDT_{HDR} by performing HDR processing (e.g., HDR merging) on the third image data IDT3 and the fourth image data IDT4. The fourth processing module 44 may be referred to as an HDR merger or an HDR processing circuit. Hereinafter, the fourth processing module 44 is referred to as an HDR merger.

For example, the HDR merger 44 may perform phase correction, brightness normalization, weighted sum, blur artifact removal, and dynamic range compression (DRC) on the third image data IDT3 and the fourth image data IDT4.

The HDR merger 44 may perform HDR processing on the third image data IDT3 and the fourth image data IDT4 according to Equation 1.

$${P}_{H} = α \cdot {n}_{L 1} \cdot {P}_{L 1} + ( 1 - α ) \cdot {n}_{L 2} \cdot H ( {P}_{L 2} ) \qquad [ Equation 1 ]$$

Here, P_{L1} and P_{L2} represent pixel data of the third image data IDT3 and pixel data of the second image data IDT2, respectively. P_{H} represents pixel data of the HDR image data IDT_{HDR}. P_{L1}, P_{L2} and P_{H} represent pixel data located at spatially identical points in the third image data IDT3, the second image data IDT2, and the HDR image data IDT_{HDR}. n_{L1} and n_{L2} represent normalization factors for matching brightness, H represents a phase shift filter (or an interpolator filter for phase shift), and α represents a weight.

H may be expressed through a convolution operation according to Equation 2.

$$y = H ( X ) = h * x \qquad [ Equation 2 ]$$

Here, h is a filter coefficient and is determined by a Spline interpolation scheme. However, various interpolation schemes, such as B-Spline, Cubic Spline, Lagrange interpolation, Hermite interpolation, and Catmull-Rom interpolation may also be used.

The weight a may be determined by a value of pixel data of the third image data IDT3 or a luma value of the pixel data. Since the noise levels of the third image data IDT3 and the second image data IDT2 are different, the difference in noise may be noticeable when α is “1” or “0”. Therefore, Alpha-blending may be used to seamlessly convert image data.

The third image data IDT3 and the second image data IDT2 may have different phase shift or spatial frequency characteristics. The HDR merger 44 may remove the false color caused by such the difference in characteristics.

In addition, the HDR merger 44 may perform tone mapping on the third image IDT3 by compressing the dynamic range. For example, since the third image data IDT3 includes only the green pixel data PXDg, the dynamic range of only the green pixel data PXDg may be extended in the HDR image data IDT_{HDR}. Accordingly, the number of bits of the green pixel data PXDg may be different from the numbers of bits of red pixel data PXDr and blue pixel data PXDb. For example, the red pixel data PXDr and the blue pixel data PXDb may include 10 bits and the green pixel data PXDg may include 12 bits. The HDR merger 44 may compress the dynamic range of the green pixel data PXDg and may adjust the number of bits of the green pixel data PXDg such that the number of bits of the red pixel data PXDr, the number of bits of the blue pixel data PXDb, and the number of bits of the green pixel data PXDg are the same.

The fifth processing module 45 may perform post-processing on the HDR image data IDT_{HDR} generated from the HDR merger 44 and may output the HDR image data IDT_{HDR}. For example, the post-processing may include various processes, such as processing to improve image quality, including noise removal, brightness adjustment, and sharpness adjustment, and image processing to change image size and data format. As another example, the fifth processing module 45 may perform some processing functions of the third processing module 43.

The image signal processor 140a may be implemented as hardware or may be implemented as a combination of hardware and software (or firmware).

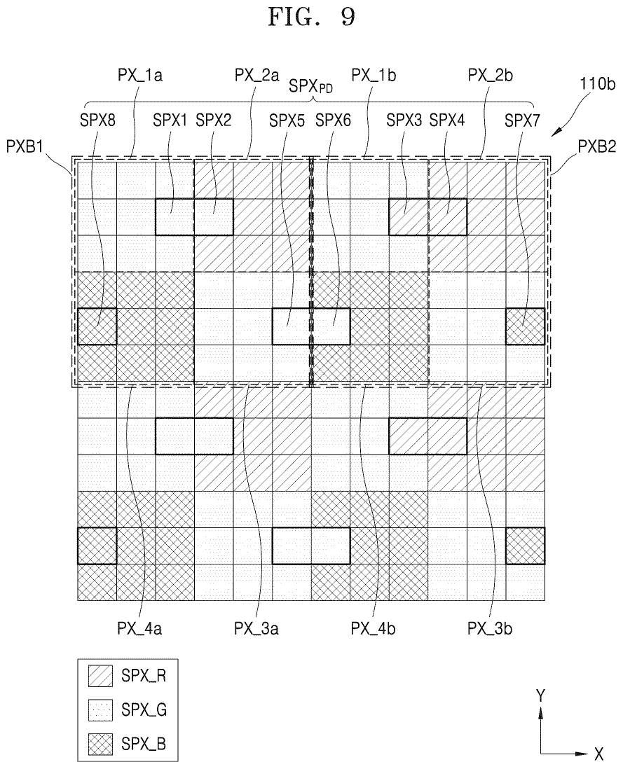

FIG. 9 is a diagram of an implementation of a pixel array included in an image sensor, according to one or more embodiments. A pixel array 110b may be applied to the image sensor 100 of FIG. 1.

Referring to FIG. 9, each of a plurality of pixels PX_1a, PX_2a, PX_3a, PX_4a, PX_1b, PX_2b, PX_3b, and PX_4b may include nine sub-pixels SPX arranged in a 3×3 matrix (in the Y-axis direction and the X-axis direction). A first pixel block PXB1 and a second pixel block PXB2 may be repeatedly arranged. In the first pixel block PXB1, the first pixel PX_1a and the third pixel PX_3a may include nine green sub-pixels SPX_G, the second pixel PX_2a may include eight red sub-pixels SPX_R and one green sub-pixel SPX_G, and the fourth pixel PX_4a may include eight blue sub-pixels SPX_B and one green sub-pixel SPX_G. In the second pixel block PXB2, the first pixel PX_1b may include eight green sub-pixels SPX_G and one red sub-pixel SPX_R, and the third pixel PX_3b may include eight green sub-pixels SPX_G and one blue sub-pixel SPX_B. The second pixel PX_2b may include nine red sub-pixels SPX_R and the fourth pixel PX_4b may include nine blue sub-pixels SPX_B.

In the pixel array 110b of FIG. 9, the phase detection sub-pixel SPX_{PD}, for example, the first to eighth sub-pixels SPX1 to SPX8, may include not only the green sub-pixel SPX_G but also the red sub-pixel SPX_R and the blue sub-pixel SPX_B.

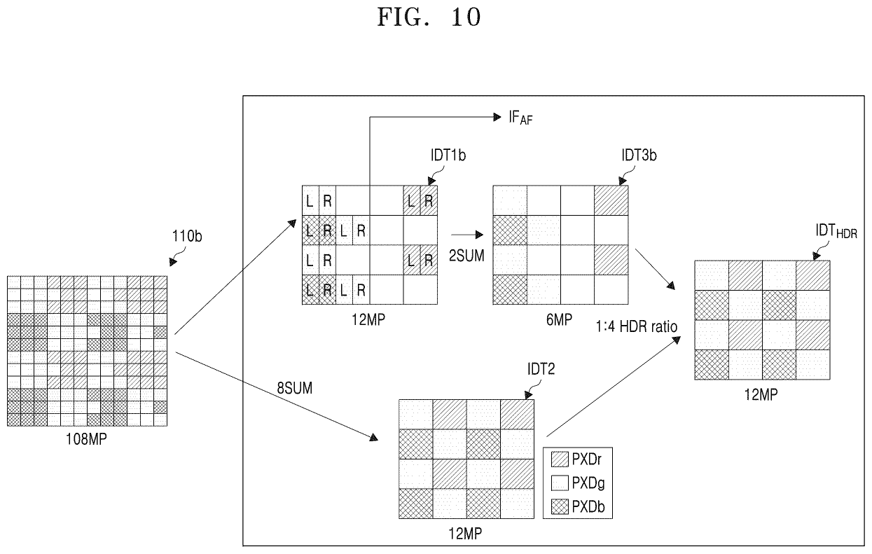

FIG. 10 is a diagram illustrating an operating method of an image sensor, according to one or more embodiments. FIG. 10 illustrates a method in which the image sensor (100 of FIG. 1) generates auto-focus information IF_{AF} and HDR image data IDT_{HDR} based on pixel signals read out from the pixel array 110b of FIG. 9 in the HDR mode.

Referring to FIGS. 1, 9, and 10, the ADC circuit (130 of FIG. 1) may receive the plurality of phase detection pixel signals from the plurality of phase detection sub-pixels SPX_{PD} of the pixel array 110b and may generate the first image data IDT1b based on the plurality of phase detection pixel signals. As described above with reference to FIG. 9, the plurality of phase detection sub-pixels SPX_{PD} may include the green sub-pixel SPX_G, the red sub-pixel SPX_R, and the blue sub-pixel SPX_B. Thus, the first image data IDT1b may include the plurality of pieces of green pixel data PXDg, the plurality of pieces of red pixel data PXDr, and the plurality of pieces of blue pixel data PXDb. For example, when the pixel array 110a has a resolution of 108 MP, the first image data IDT1b may have a resolution of 12 MP, which is 1/9 times the resolution of the pixel array 110a.

The ADC circuit 130 may receive a plurality of summed pixel signals from the pixel array 110b and may generate the second image data IDT2 based on the plurality of summed pixel signals. As the generating of the second image data IDT2 is the same as the generating of the second image data IDT2 described with reference to FIG. 3, the redundant description thereof may be omitted.

The first image data IDTb may include first pixel data L and second pixel data R. The image signal processor 140 may generate the auto-focus information IF_{AF} based on the plurality of pieces of first pixel data L and the plurality of pieces of second pixel data R of the first image data IDT1b.

The image signal processor 140 may generate third image data IDT3b by summing (or digital summing) the first pixel data L and the second pixel data R of the first image data IDT1b. The third image data IDT3b may have a resolution of 6 MP.

The image signal processor 140 may generate HDR image data IDT_{HDR} by merging (or HDR merging) the third image data IDT3b with the second image data IDT2. Since the third image data IDT3b includes the green pixel data PXDg, the red pixel data PXDr, and the blue pixel data PXDb, the HDR image data IDT_{HDR} in which the dynamic ranges of the green pixel data PXDg, the red pixel data PXDr, and the blue pixel data PXDb are extended may be generated from the second image data IDT2.

The resolution of the HDR image data IDT_{HDR} may be 12 MP, which is the same as the resolution of the second image data IDT2. As the third image data IDT3b has a value 2SUM, which is the digital sum of the pixel signals of two sub-pixels SPX and the second image data IDT2 has a value 8SUM which is the sum of the pixel signals of eight sub-pixels SPX, an HDR ratio of the third image data IDT3b to the second image IDT2 may be 1:4.

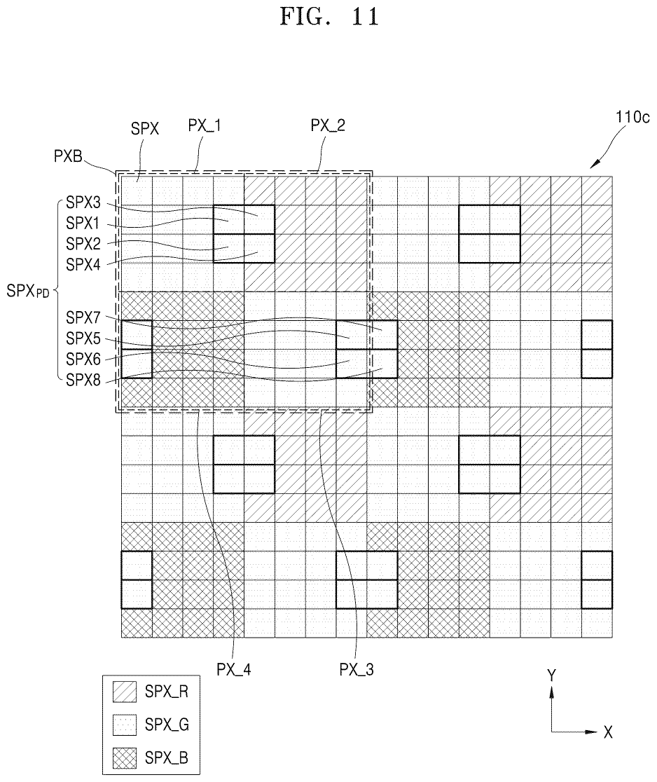

FIG. 11 is a diagram of an implementation of a pixel array included in an image sensor, according to one or more embodiments. A pixel array 110c may be applied to the image sensor 100 of FIG. 1.

Referring to FIG. 11, each of a plurality of pixels, for example, first to fourth pixels PX_1, PX_2, PX_3, and PX_4, may include 16 sub-pixels SPX arranged in a 4×4 matrix (in the Y-axis direction and the X-axis direction). A pixel block PXB including the first to fourth pixels PX_1, PX_2, PX_3, and PX_4 may be repeatedly arranged.

The first pixel PX_1 and the third pixel PX_3 may include 16 green sub-pixels SPX_G, the second pixel PX_2 may include 14 red sub-pixels SPX_R and 2 green sub-pixels SPX_G, and the fourth pixel PX_4 may include 14 blue sub-pixels SPX_B and 2 green sub-pixels SPX_G.

Each of the first to fourth pixels PX_1, PX_2, PX_3, and PX_4 may include a plurality of phase detection sub-pixels SPX_{PD}, e.g., two phase detection sub-pixels SPX_{PD}. For example, the first sub-pixel SPX1 and the second sub-pixel SPX2 of the first pixel PX_1, the third sub-pixel SPX3 and the fourth sub-pixel SPX4 of the second pixel PX_2, the fifth sub-pixel SPX5 and the sixth sub-pixel SPX6 of the third pixel PX_3, and the seventh sub-pixel SPX7 and the eighth sub-pixel SPX8 of the fourth pixel PX_4 may include phase detection sub-pixels SPX_{PD}.

Two pairs of sub-pixels SPX provided in different pixels may include phase detection sub-pixels SPX_{PD}, wherein each of the two pairs of phase detection sub-pixels SPX_{PD} may share and correspond to a microlens. For example, the first sub-pixel SPX1 and the third sub-pixel SPX3 may share and correspond to a microlens (e.g., the first microlens ML1 in FIGS. 4A and 4B) and the second sub-pixel PX2 and the fourth sub-pixel SPX4 may share and correspond to a microlens. The fifth sub-pixel SPX5 and the seventh sub-pixel SPX7 may share and correspond to a microlens and the sixth sub-pixel SPX6 and the eighth sub-pixel SPX8 may share and correspond to a microlens.

In one or more embodiments, four sub-pixels SPX provided in different pixels may include phase detection sub-pixels SPX_{PD} and the may share and correspond to a microlens. For example, the first to fourth sub-pixels SPX1 to SPX4 may share and correspond to a microlens and the fifth to eighth sub-pixels SPX5 to SPX8 may share and correspond to a micro-lens. The microlens may have a shape similar to a shape of a microlens (e.g., the second microlens ML2 in FIGS. 4A and 4B) provided in another sub-pixel SPX. However, the size of the microlens may be greater than the size of the microlens provided in the other sub-pixels SPX.

In the pixel array 110c of FIG. 11, the phase detection sub-pixels SPX_{PD}, for example, the first to eighth sub-pixels SPX1 to SPX8, include the green sub-pixels SPX_G. However, embodiments are not limited thereto. As described with reference to FIG. 9, the phase detection sub-pixels SPX_{PD} of one pixel block PXB may include green sub-pixels SPX_G and the phase detection sub-pixels SPX_{PD} of other adjacent pixel blocks PXB may include red sub-pixels SPX_R or blue sub-pixels SPX_B.

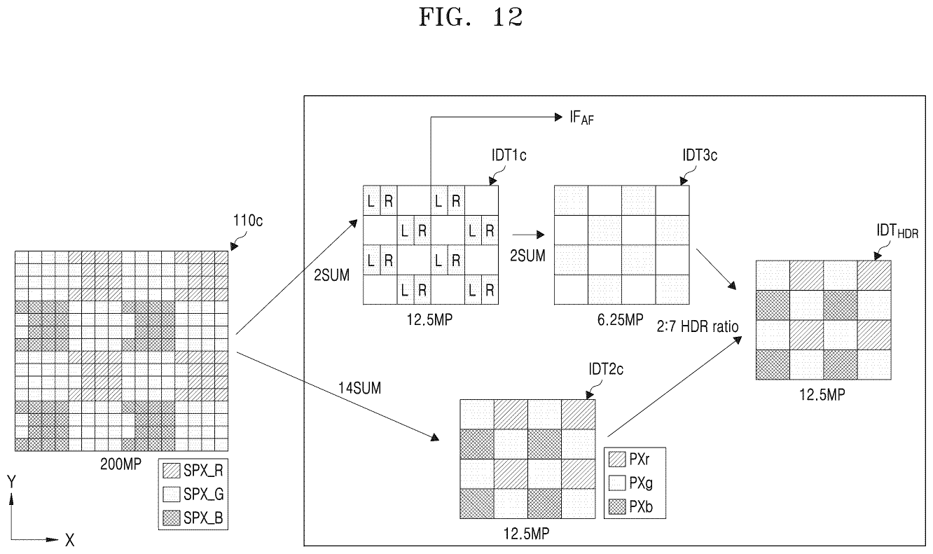

FIG. 12 is a diagram illustrating an operating method of an image sensor, according to one or more embodiments. FIG. 12 illustrates a method in which the image sensor (100 of FIG. 1) generates auto-focus information IF_{AF} and HDR image data IDT_{HDR} based on pixel signals read out from the pixel array 110c of FIG. 11 in the HDR mode.

Referring to FIGS. 1, 11, and 12, the ADC circuit (130 of FIG. 1) may receive a plurality of phase detection pixel signals from the plurality of phase detection sub-pixels SPX_{PD} of the pixel array 110c and may generate first image data IDT1c based on the plurality of phase detection pixel signals.

As described with reference to FIG. 11, two sub-pixels SPX in each of the first to fourth pixels PX_1, PX_2, PX_3, and PX_4 include phase detection sub-pixels SPX_{PD}. The phase detection pixel signals generated from the two phase detection sub-pixels SPX_{PD} may be summed (analog summation) to output a summed phase detection pixel signal. The ADC circuit 130 may generate the first image data IDT1c based on a plurality of summed phase detection pixel signals.

The first image data IDT1c may include first pixel data L and second pixel data R. The first pixel data L corresponds to a value 2SUM obtained by summing the phase detection pixel signals generated from the phase detection sub-pixels SPX_{PD} (e.g., the first and second sub-pixels SPX1 and SPX2) located in the first direction among the phase detection sub-pixels SPX_{PD} (e.g., the first to fourth sub-pixels SPX1 to SPX4) that are provided in different pixels and share and correspond to the microlens. The second pixel data R corresponds to a value 2SUM obtained by summing the phase detection pixel signals generated from the phase detection sub-pixels SPX_{PD} (e.g., the third and fourth sub-pixels SPX3 and SPX4) located in the second direction among the phase detection sub-pixels SPX_{PD} (e.g., the first to fourth sub-pixels SPX1 to SPX4) that are provided in different pixels and share and correspond to the microlens.

The plurality of phase detection sub-pixels SPX_{PD} may include the green sub-pixels SPX_G. Thus, the first image data IDT1c may include green image data including a plurality of pieces of green pixel data PXDg. When the pixel array 110c has a resolution of 200 MP, the first image data IDT1c may have a resolution of 12.5 MP, which is 1/16 times the resolution of the pixel array 110C.

When the plurality of phase detection sub-pixels SPX_{PD} include the green sub-pixel SPX_G, the red sub-pixel SPX_R, and the blue sub-pixel SPX_B, the first image data IDT1c may include image data of a Bayer pattern, such as the first image data IDT1b of FIG. 10.

The ADC circuit 130 may receive a plurality of summed pixel signals from the pixel array 110c and may generate second image data IDT2c based on the plurality of summed pixel signals. Each piece of pixel data of the second image data IDT2c has a value which is the sum of pixel signals generated from 14 sub-pixels SPX other than 2 phase detection sub-pixels SPX_{PD} among 16 sub-pixels SPX of the corresponding pixel PX in the pixel array 110c. The four pieces of pixel data arranged in a 2×2 matrix in the second image data IDT2c may correspond to the first pixel PX_1, the second pixel PX_2, the third pixel PX_3, and the fourth pixel PX_4 of the pixel array 110c, respectively, and may include green pixel data PXDg, red pixel data PXDr, and blue pixel data PXDb. The second image data IDT2c may include image data of a Bayer pattern.

For example, when the pixel array 110c has a resolution of 200 MP, the second image data IDT2 may have a resolution of 12.5 MP, which is 1/16 times the resolution of the pixel array 110a.

The image signal processor 140 may generate auto-focus information IF_{AF} based on the first image data IDT1c. The image signal processor 140 may generate the third image data IDT3c by summing (or digital summing: 2SUM) the first pixel data L and the second pixel data R of the first image data IDT1c. The third image data IDT3c may have a resolution of 6.25 MP.

The image signal processor 140 may generate HDR image data IDT_{HDR} by merging (or HDR merging) the third image data IDT3c with the second image data IDT2c. Since the third image data IDT3c includes the green pixel data PXDg, the HDR image data IDT_{HDR} in which the dynamic range of the green pixel data PXDg is extended may be generated from the second image data IDT2c.

The resolution of the HDR image data IDT_{HDR} may be 12.5 MP, which is the same as the resolution of the second image data IDT2c. As the third image data IDT3c has a value 4SUM which is the analog sum and digital sum of pixel signals of 4 green sub-pixels SPX_G and the second image data IDT2c has a value 14SUM which is the sum of pixel signals of 14 green sub-pixels SPX_G, an HDR ratio of the third image data IDT3c to the second image Data IDT2c may be 2:7.

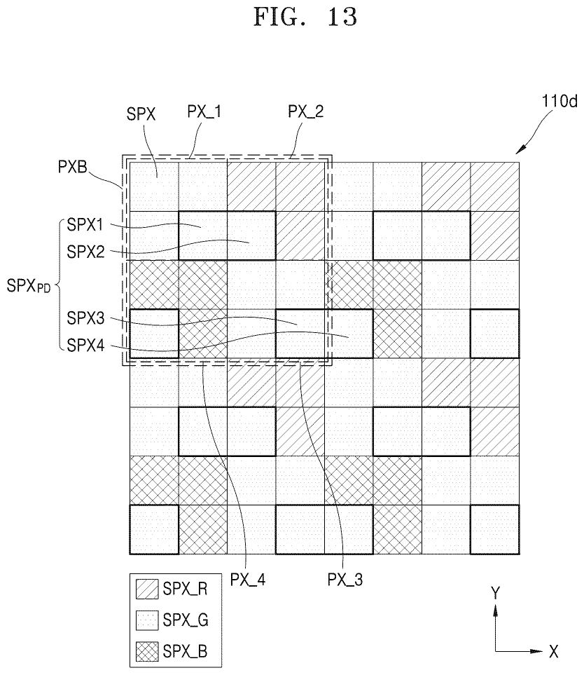

FIG. 13 is a diagram of an implementation of a pixel array included in an image sensor, according to one or more embodiments. A pixel array 110d may be applied to the image sensor 100 of FIG. 1.

Referring to FIG. 13, each of the plurality of pixels PX_1, PX_2, PX_3, and PX_4 may include four sub-pixels SPX arranged in a 2×2 matrix (in the Y-axis direction and the X-axis direction). A pixel block PXB including the first to fourth pixels PX_1, PX_2, PX_3, and PX_4 may be repeatedly arranged.

The first pixel PX_1 and the third pixel PX_3 may include four green sub-pixels SPX_G, the second pixel PX_2 may include three red sub-pixels SPX_R and one green sub-pixel SPX_G, and the fourth pixel PX_4 may include three blue sub-pixels SPX_B and one green sub-pixel SPX_G. The phase detection sub-pixels SPX_{PD}, for example, the first to fourth sub-pixels SPX1 to SPX4, may include the green sub-pixels SPX_G.

Referring to FIG. 1, the ADC circuit (130 of FIG. 1) may receive the plurality of phase detection pixel signals from the plurality of phase detection sub-pixels SPX_{PD} of the pixel array 110d and may generate the first image data IDT1 based on the plurality of phase detection pixel signals. In addition, the ADC circuit 130 may receive a plurality of summed pixel signals from the pixel array 110d and may generate second image data IDT2 based on the plurality of summed pixel signals. Each piece of pixel data of the second image data IDT2 has a value which is the sum of pixel signals generated from three sub-pixels SPX other than the phase detection sub-pixels SPX_{PD} among the four sub-pixels SPX of the corresponding pixel PX in the pixel array 110d.

The image signal processor (140 in FIG. 1) may generate auto-focus information IF_{AF} based on the first image data IDT1 and may generate HDR image data IDT_{HDR} by using the first image data IDT1 and the second image data IDT2.

FIGS. 2 to 13 are directed to methods of generating the first image data (IDT1 in FIG. 1) based on the phase detection pixel signals, generating the second image data (IDT2 in FIG. 2) based on the summed pixel signals, generating the auto-focus information IF_{AF} based on the first image data IDT1, and generating the HDR image data IDT_{HDR} by HDR merging the first image data IDT1 with the second image data IDT2, according to one or more embodiments, in pixel arrays 110a, 110b, 110c, and 110d having various structures as illustrated in FIGS. 2, 9, 11, and 13. The methods described above may be applied to various pixel arrays other than the pixel arrays 110a, 110b, 110c, and 110d shown with reference to FIGS. 2, 9, 11, and 13.

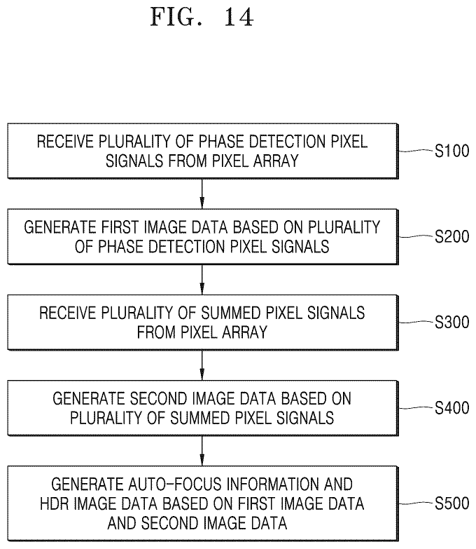

FIG. 14 is a flowchart of an operating method of an image sensor, according to one or more embodiments. The method of FIG. 14 may be applied to the image sensor 100 of FIG. 1. The above descriptions with reference to FIGS. 1 to 13 may be applied to the method of FIG. 14.

Referring to FIGS. 1 and 14, the ADC circuit 130 may receive a plurality of phase detection pixel signals from the pixel array 110 in operation S100. Each of the plurality of pixels included in the pixel array 110 may include a plurality of sub-pixels arranged in an N×N matrix. One or more sub-pixels of the plurality of sub-pixels may include phase detection sub-pixels. A pair of phase detection sub-pixels adjacent to each other in the first direction in pixels adjacent to each other in the first direction may share and correspond to a microlens and may include a color filter of the same color.

The ADC circuit 130 may generate the first image data IDT1 based on the plurality of phase detection pixel signals in operation S200. The first image data IDT1 may include a plurality of pieces of pixel data corresponding to the phase detection pixel signals, respectively, generated from the plurality of phase detection sub-pixels of the pixel array 110. The first image data IDT1 may include first pixel data L (e.g., left pixel data) and second pixel data R (e.g., right pixel data).

The ADC circuit 130 may receive a plurality of summed pixel signals from the pixel array 110 in operation S300. The summed pixel signal has a value which is the sum of pixel signals generated from sub-pixels, other than at least one phase detection sub-pixel, among the N sub-pixels SPX of the corresponding pixel PX.

The ADC circuit 130 may generate the second image data IDT2 based on the plurality of summed pixel signals in operation S400. The four pieces of pixel data arranged in a 2×2 matrix in the second image data IDT2 may include green pixel data, red pixel data, green pixel data, and blue pixel data, respectively. The second image data IDT2 may include image data of a Bayer pattern.

The image signal processor 140 may generate auto-focus information IF_{AF} and HDR image data IDT_{HDR} based on the first image data IDT1 and the second image data IDT2 in operation S500.

The image signal processor 140 may generate the auto-focus information IF_{AF} based on the first image data IDT1. The image signal processor 140 may detect a phase difference between an image according to a plurality of pieces of first pixel data and an image according to a plurality of pieces of second pixel data in the first image data IDT1 and may generate auto-focus information IF_{AF} including the detected phase difference. In one or more embodiments, the generating of the auto-focus information IF_{AF} may be performed before operations S300 and S400 or may be performed simultaneously with operations S300 and S400.

The image signal processor 140 may generate third image data by summing (or digital summing) the first pixel data and the second pixel data of the first image data IDT1. The third image data does not include phase information. The image signal processor 140 may generate HDR image data IDT_{HDR} by merging the third image data with the second image data IDT2.

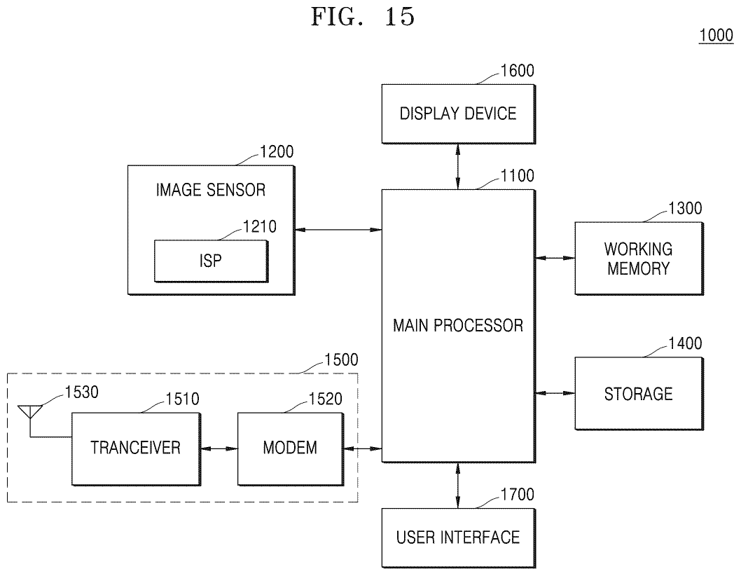

FIG. 15 is a block diagram of an electronic device including an image sensor, according to one or more embodiments. An electronic device 1000 of FIG. 15 may include a portable device.

Referring to FIG. 15, the electronic device 1000 may include a main processor 1100, an image sensor 1200, a display device 1600, a working memory 1300, a storage 1400, a user interface 1700, and a wireless transceiver 1500.

The main processor 1100 may be implemented as a system-on-a-chip (SoC) that controls the overall operation of the electronic device 1000 and drives an application program, an operating system, and the like. The main processor 1100 may include an application processor. The main processor 1100 may provide the image data provided from the image sensor 1200 to the display device 1600 or may store the image data in the storage 1400. In one or more embodiments, the main processor 1100 may include an image processing circuit and may perform image processing, such as image quality adjustment and data format change, on the image data received from the image sensor 1200.

The image sensor 100 described with reference to FIGS. 1 to 14 may be applied to the image sensor 1200. Each of the plurality of pixels included in the pixel array (110 in FIG. 1) of the image sensor 1200 may include a plurality of sub-pixels arranged in an N×N matrix, wherein the plurality of sub-pixels may share and correspond to a floating diffusion node. For example, the plurality of sub-pixels may be electrically connected to the same floating diffusion node. At least one sub-pixel of the plurality of sub-pixels included in the pixel may include a phase detection sub-pixel. A pair of adjacent phase detection sub-pixels in two adjacent pixels, e.g., a first sub-pixel of a first pixel and a second sub-pixel of a second pixel, may share and correspond to a micro-lens.

The image sensor 1200 may read out a plurality of phase detection pixel signals from the pixel array 110 and may generate first image data including auto-focusing data based on the plurality of phase detection pixel signals. The image sensor 1200 may also read out a plurality of summed pixel signals from the pixel array 110 and may generate second image data based on the plurality of summed pixel signals. The summed pixel signal has a value which is the sum of pixel signals of sub-pixels, other than at least one phase detection pixel signal, among the plurality of sub-pixels included in the pixel. Therefore, the luminance of the second image data is greater than the luminance of the first image data. The image sensor 1200 may generate auto-focus information based on the first image data and generate HDR image data based on the first image data and the second image data.

As a separate readout operation for generating relatively low-luminance image data in the image sensor 1200 is not required for generating HDR image data, the number of readouts and the readout time may be reduced. Accordingly, the frame rate of the image sensor 1200 may be increased and power consumption may be reduced.

The image sensor 1200 may provide the auto-focus information and the HDR image data to the main processor 1100. The main processor 1100 may display the HDR image data on the display device 1600 or may store the HDR image data in the storage 1400. The main processor 1110 may also calculate or obtain a focal length of an objective lens of an image device on which the image sensor 1200 is mounted, based on the auto-focus information, to perform auto-focusing. The main processor 1110 may provide a signal for moving the objective lens according to the calculated or obtained focal length to the image device.

The working memory 1300 may be implemented as volatile memory, such as dynamic random-access memory (DRAM), static RAM (SRAM), or non-volatile resistive memory, such as ferroelectric RAM (FeRAM), resistive RAM (RRAM), or phase-change RAM (PRAM). The working memory 1300 may store programs and/or data processed or executed by the main processor 1100.

The storage 1400 may be implemented as a non-volatile memory device, such as NAND flash, resistive memory, and the like. For example, the storage 1400 may be provided as a memory card, such as a multi-media card (MMC), an embedded MMC (eMMC), a secure digital (SD) card, a micro SD card, and the like. The storage 1400 may store image data provided from the image sensor 1200.

The user interface 1700 may be implemented as various devices capable of receiving a user input, such as, for example, a keyboard, a curtain key panel, a touch panel, a fingerprint sensor, and a microphone. The user interface 1700 may receive a user input and provide a signal corresponding to the received user input to the main processor 1100.

The wireless transceiver 1500 may include a transceiver 1510, a modem 1520, and an antenna 1530. The wireless transceiver 1500 may receive data or transmit data through wireless communication with an external device.

While embodiments have been described with reference to the figures, it will be understood by those of ordinary skill in the art that various changes in form and details may be made therein without departing from the spirit and scope as defined by the following claims and their equivalents and their equivalents.

What is claimed is:

1. An image sensor, comprising:
a pixel array comprising a plurality of pixels in a matrix form, each pixel of the plurality of pixels comprising a plurality of sub-pixels in a plurality of rows and a plurality of columns and connected to a floating diffusion node, a first sub-pixel of a first pixel among the plurality of pixels and a second sub-pixel of a second pixel among the plurality of pixels corresponding to a first microlens;
a readout circuit configured to:
generate first image data based on a first pixel signal output from the first sub-pixel and a second pixel signal output from the second sub-pixel; and
generate second image data based on a third pixel signal output from sub-pixels, other than the first sub-pixel, of the plurality of sub-pixels of the first pixel and a fourth pixel signal output from sub-pixels, other than the second sub-pixel, of the plurality of the sub-pixels of the second pixel; and
an image signal processor configured to generate high dynamic range (HDR) image data based on the first image data and the second image data, and generate auto-focus information based on the first image data.

2. The image sensor of claim 1, wherein the readout circuit is further configured to:
read out the first pixel signal from the first pixel and the second pixel signal from the second pixel in a first period of a readout period; and
read out the third pixel signal from the first pixel and the fourth pixel signal from the second pixel in a second period of the readout period.

3. The image sensor of claim 1, wherein the readout circuit is further configured to:
receive the first pixel signal and the third pixel signal through a first column line connected to the first pixel; and
receive the second pixel signal and the fourth pixel signal through a second column line connected to the second pixel.

4. The image sensor of claim 1, wherein each of sub-pixels of a plurality of sub-pixels in the first pixel other than the first sub-pixel and sub-pixels of a plurality of sub-pixels of the second pixel other than the second sub-pixel correspond to a second microlens, and
wherein a shape of the second microlens is different from a shape of the first microlens.

5. The image sensor of claim 1, wherein each of a plurality of sub-pixels in the first pixel and the second sub-pixel in the second pixel comprises a color filter of a first color and sub-pixels of a plurality of sub-pixels of the second pixel other than the second sub-pixel comprise a color filter of a second color, and
wherein the second color is different from the first color.

6. The image sensor of claim 1, wherein the first image data comprises pixel data of a first color and the second image data comprises image data of a Bayer pattern.

7. The image sensor of claim 1, wherein the image signal processor is further configured to:
generate third image data by summing first pixel data corresponding to the first pixel signal with second pixel data corresponding to the second pixel signal, included in the first image data; and
merging the third image data with the second image data to generate the HDR image data.

8. The image sensor of claim 1, wherein a third sub-pixel in a third pixel and a fourth sub-pixel in a fourth pixel among the plurality of pixels correspond to a third microlens,
wherein a shape of the third microlens is the same as a shape of the first microlens, and
wherein the readout circuit is further configured to generate the first image data based on the first pixel signal, the second pixel signal, a fifth pixel signal generated from the third sub-pixel, and a sixth pixel signal generated from the fourth sub-pixel.

9. The image sensor of claim 8, wherein a plurality of sub-pixels in the first pixel, the second sub-pixel in the second pixel, and sub-pixels of a plurality of sub-pixels in the third pixel other than the third sub-pixel comprise a color filter of a first color,
wherein sub-pixels of a plurality of sub-pixels in the second pixel other than the second sub-pixel comprise a color filter of a second color,
wherein the third sub-pixel in the third pixel and a plurality of sub-pixels in the fourth pixel comprise a color filter of a third color, and
wherein the first color, the second color, and the third color are different from each other.

10. The image sensor of claim 9, wherein the first image data comprises pixel data of the first color, comprises pixel data of the second color, and comprises pixel data of the third color, and the second image data comprises image data of a Bayer pattern.

11. An image sensor, comprising:
a pixel array comprising a plurality of pixels in a matrix form, each pixel of the plurality of pixels comprising a plurality of sub-pixels in a plurality of rows and a plurality of columns and connected to a floating diffusion node, in a first pixel and a second pixel connected to adjacent column lines among the plurality of pixels, each of a first sub-pixel in the first pixel and a second sub-pixel in the second pixel comprises a color filter of a first color;
a readout circuit configured to generate first image data based on a first pixel signal generated from the first sub-pixel and a second pixel signal generated from the second sub-pixel, and generate second image data based on a third pixel signal generated from sub-pixels of the plurality of sub-pixels in the first pixel other than the first sub-pixel and a fourth pixel signal generated from sub-pixels of the plurality of the sub-pixels in the second pixel other than the second sub-pixel; and
an image signal processor configured to generate high dynamic range (HDR) image data based on the first image data and the second image data and generate auto-focus information based on the first image data.

12. The image sensor of claim 11, wherein the first sub-pixel in the first pixel and the second sub-pixel in the second pixel correspond to a first microlens,
wherein each of sub-pixels of the plurality of pixels in the first pixel other than the first sub-pixel and sub-pixels of the plurality of pixels in the second pixel other than the second sub-pixel correspond to a second microlens, and
wherein a shape of the second microlens is different from a shape of the first microlens.

13. The image sensor of claim 11, wherein the readout circuit is further configured to:
read out the first pixel signal from the first pixel and the second pixel signal from the second pixel in a first period of a readout period; and
read out the third pixel signal from the first pixel and the fourth pixel signal from the second pixel in a second period of the readout out period.

14. The image sensor of claim 11, wherein sub-pixels of the plurality of sub-pixels in the first pixel other than the first sub-pixel comprise a color filter of the first color and sub-pixels of the plurality of sub-pixels in the second pixel other than the second sub-pixel comprise a color filter of a second color, and
wherein the second color is different from the first color.

15. The image sensor of claim 11, wherein the image signal processor comprises:
an auto-focus circuit configured to generate the auto-focus information based on first pixel data corresponding to the first pixel signal and second pixel data corresponding to the second pixel signal, included in the first image data;
a digital-sum circuit configured to generate third image data by summing the first pixel data and the second pixel data; and
an HDR merging circuit configured to merge the third image data with the second image data to generate the HDR image data.

16. An operating method of an image sensor, the operating method comprising:
receiving, by an analog-to-digital conversion (ADC) circuit, a plurality of phase detection pixel signals from a pixel array;
generating, by the ADC circuit, first image data based on the plurality of phase detection pixel signals;
receiving, by the ADC circuit, a plurality of summed pixel signals from the pixel array;
generating, by the ADC circuit, second image data based on the plurality of summed pixel signals; and
generating, by an image signal processor, auto-focus information and a high dynamic range (HDR) image based on the first image data and the second image data.

17. The operating method of claim 16, wherein each pixel of the plurality of pixels in the pixel array comprises a plurality of sub-pixels in a plurality of rows and a plurality of columns and connected to a floating diffusion node, a first sub-pixel in a first pixel of the plurality of pixels and a second sub-pixel in a second pixel of the plurality of pixels correspond to a first microlens, and
wherein the plurality of phase detection pixel signals comprise a first phase detection pixel signal generated from the first sub-pixel and a second phase detection pixel signal generated from the second sub-pixel.

18. The operating method of claim 17, wherein the first sub-pixel and the second sub-pixel correspond to a first color filter.

19. The operating method of claim 17, wherein the plurality of summed pixel signals comprise a first summed pixel signal obtained by summing pixel signals generated from sub-pixels of the plurality of sub-pixels in the first pixel other than the first sub-pixel, and a second summed pixel signal obtained by summing pixel signals generated from sub-pixels of the plurality of sub-pixels in the second pixel other than the second sub-pixel.

20. The operating method of claim 16, wherein the generating of the auto-focus information and the HDR image comprises:
generating the auto-focus information based on first pixel data corresponding to left pixel signals and second pixel data corresponding to right pixel signals, in the first image data; and
summing the first pixel data and the second pixel data to generate third image data; and
merging the third image data with the second image data to generate the HDR image.
